(19) United States
(12) Patent Application Publication
(10) Pub. No.: US 2007/0211754 A1
(43) Pub. Date: Sep. 13, 2007

(54) Information processing apparatus and mail receiving method

(75) Inventors: Takeshi Tajima, Ome-shi (JP); Koichi Kaji, Hidaka-shi (JP); Toshikazu Morisawa, Tokorozawa-shi (JP); Tatsuya Aoyagi, Tachikawa-shi (JP); Kazuya Fukushima, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/714,733

(22) Filed: Mar. 7, 2007

(30) Foreign Application Priority Data
Mar. 9, 2006 (JP) 2006-064584

(51) Int. Cl. H04J 3/22

(52) U.S. Cl. 370/465

(57) ABSTRACT

According to one embodiment, an information processing apparatus, includes a communication unit making communication with a mail server and obtaining a mail, a searching unit discriminating whether or not a new mail has arrived at the mail server, a main controller controlling the communication unit and the searching unit, and obtaining a new mail, a main power supplier supplying power to the main controller, and a sub-controller. The sub-controller discriminates whether or not a new mail has arrived on the predetermined timing by the searching unit during suspension of the main controller, obtains the new mail via the communication unit if the new mail has arrived, and urges the main power supplier to supply the power and sets the main power supplier in an operable state if any item of information included in the new mail meets a predetermined condition.

### CROSS-REFERENCE TO RELATED APPLICATIONS

This application is based upon and claims the benefit of priority from Japanese Patent Application No. 2006-064584, filed Mar. 9, 2006, the entire contents of which are incorporated herein by reference.

### BACKGROUND

1. Field

One embodiment of the present invention relates to an information processing apparatus, for example, such as a personal computer and, more particularly, to an information processing apparatus capable of receiving electronic mails and a control method applied to the information processing apparatus.

2. Description of the Related Art

Recently, various kinds of portable personal computers in the laptop type and the notebook type have been developed. Computers of these kinds comprise communication devices executing communications with the outside. Even if a power of a main component of the computer is turned off, the electric power is supplied to an auxiliary processor provided separately from the main component, independently of a power supply condition of the main component.

By the auxiliary processor, sending and reception of mails are executed and a result of the sending and reception is displayed on a sub-display unit provided on a rear side, etc. of a main display unit. Thus, the overall computer including a main processor does not need to be in an operable state at the standby time, and the power stored in a battery can be saved (Jpn. Pat. Appln. KOKAI Publication No. 2005-228327).

After the mails are received and the receiving condition is displayed on the sub-display unit, however, the user needs to confirm the contents of the display and discriminate whether or not the computer should be activated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary a perspective view showing an outer appearance of an information processing apparatus according to an embodiment of the invention;

FIG. 2 is an exemplary a perspective view showing an outer appearance of the information processing apparatus shown in FIG. 1 when a display unit is closed in the embodiment;

FIG. 3 is an exemplary a block diagram showing a system configuration of the information processing apparatus shown in FIG. 1 in the embodiment;

FIG. 4 is an exemplary an illustration showing a state of shifting a system state of the information processing apparatus shown in FIG. 1 in the embodiment;

FIG. 5 is an exemplary a flowchart showing basic processing executed by an APU of the information processing apparatus shown in FIG. 1 in the embodiment; and

FIG. 6 is an exemplary an illustration showing relationships among the OS, utility, communication program, CPU and APU in the embodiment.

### DETAILED DESCRIPTION

Various embodiments according to the invention will be described hereinafter with reference to the accompanying drawings. In general, according to one embodiment of the invention, an information processing apparatus, comprises a communication unit making communication with a mail server and obtaining a mail, a searching unit discriminating whether or not a new mail has arrived at the mail server, a main controller controlling the communication unit and the searching unit, and obtaining a new mail, a main power supplier supplying power to the main controller, and a sub-controller. The sub-controller discriminates whether or not a new mail has arrived on predetermined timing by the searching unit during suspension of the main controller, obtains the new mail via the communication unit if the new mail has arrived, and urges the main power supplier to supply the power and sets the main power supplier in an operable state if any item of information included in the new mail meets a predetermined condition.

An embodiment of the present invention is described with reference to the accompanying drawings.

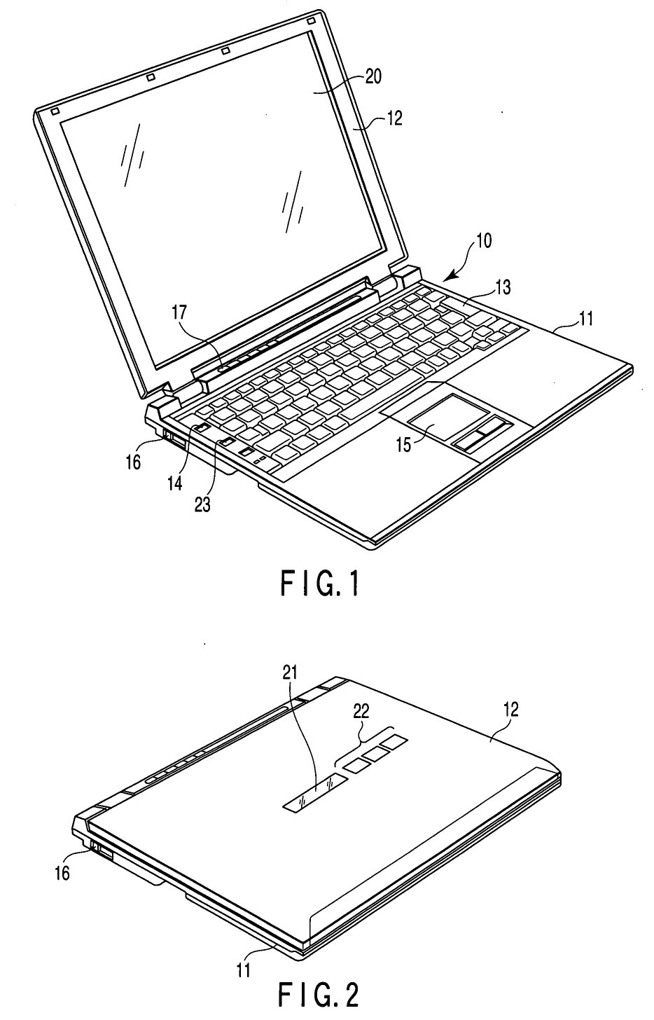

First, a configuration of an information processing apparatus according to the embodiment of the present invention is described with reference to FIG. 1 and FIG. 2. The information processing apparatus is implemented as a battery-operated portable notebook-type personal computer 10. Even if a power of a main component in the computer 10 is turned off, electronic mails can be checked on the predetermined timing by an auxiliary processor (APU: Auxiliary Processing Unit) to be described later. All the components including the main component of the computer 10 becomes operable only when the computer 10 receives an electronic mail meeting the predetermined conditions.

FIG. 1 is a perspective view showing an outer appearance of the information processing apparatus with the display unit opened.

The computer 10 is composed of a main body 11 and a display unit 12. A display device composed of an LCD 20 (Liquid Crystal Display) is embedded in the display unit 12. A display screen of the LCD 20 is located approximately at the center of the display unit 12.

The display unit 11 is supported on the computer 11 so as to freely pivot between an opened position at which a top face of the main body 11 is exposed to the main body 11 and a closed position at which the display unit 12 covers the top face. The main body 11 has a housing shaped in a thin box, and comprises on the top face a keyboard 13, a power button 14 for power-on/power-off of the computer 10, a mail button to start mail software, a touch pad 15 and an LED (Light Emitting Diode) 17. A communication device is built in the main body 11. With the communication device, the APU alone can execute data communication with a mail server.

A wireless communication switch 16 is provided on a left side surface of the main body 11. The wireless communication switch 16 is an operation switch for permitting or prohibiting the execution of wireless communication. The wireless communication switch 16 is set in a first state representing the permission of the execution of wireless communication or a second state representing the prohibition of the execution of wireless communication.

As the above communication device, for example, a wireless communication device can be employed. In this case, when the wireless communication switch 16 is set in the second state, transmission and reception of electronic mails are not executed and are cancelled even if the timing of executing the reception of electronic mails by the APU has come. Thus, it is thereby possible to preliminarily prevent execution of the wireless communication for reception of electronic mails, at a location such as a hospital where use of the radio wave is restricted.

FIG. 2 is a perspective view showing an outer appearance of the information processing apparatus 10 with the display unit 12 closed. A sub-display 21 is arranged on a rear surface of the display unit 12. The sub-display 21 is used to display the contents of sending and reception of the electronic mails by the APU and various kinds of status. For example, the sub-display 21 displays information indicating the field strength level of radio signals sent from the base station, information indicating reception of a new electronic mail, etc. With the sub-display 21, the user can confirm whether or not the current position is within the range of communication, reception, etc. even if the display unit 12 is closed. Operation buttons 22 are arranged near the sub-display 21. With these buttons, scroll, enter, simple view of electronic mails, etc. can be executed.

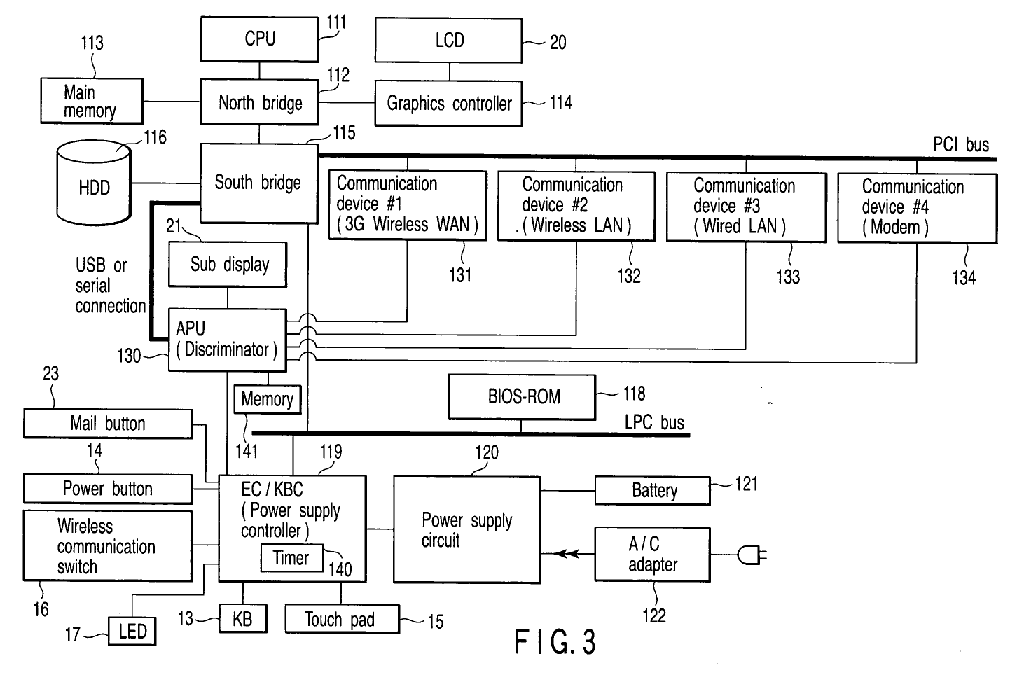

FIG. 3 shows an example of a system configuration of the computer 10.

The computer 10 comprises a CPU 111, a north bridge 112, a main memory 113, a graphics controller 114, a south bridge 115, a hard disk drive (HDD) 116, a flush BIOS-ROM 118, an embedded controller/keyboard controller IC (EC/KBC) 119, a power supply circuit 120, an APU 130, communication devices 131 to 134, etc.

The CPU 111 is a main processor controlling the operations of the computer 10. The CPU 111 executes the operating system and various kinds of application programs/utility programs loaded on the main memory 113 by the HDD 116. In addition, the CPU 111 also executes the system BIOS (Basic Input Output System) stored in the flush BIOS-ROM 118. The BIOS is a program for the hardware control.

The north bridge 112 is a bridge device making connection between a local bus of the CPU 111 and the south bridge 115. The north bridge 112 also has a function of executing communication with the graphics controller 114 via a PCI Express bus, etc. A memory controller for controlling the main memory 113 is built in the north bridge 112.

The graphics controller 114 is a display controller which controls the LCD 20 employed as a display monitor of the computer 10. The south bridge 115 is connected to a PCI (Peripheral Component Interconnect) bus and an LPC (Low Pin Count) bus. In addition, an IDE controller controlling the HDD 116 is built in the south bridge 115.

The embedded controller/keyboard controller IC (EC/KBC) 119 is a one-chip microcomputer. On the embedded controller/keyboard controller IC 119, an embedded controller for power supply management, and a keyboard controller controlling the keyboard (KB) 13, the touch pad 15, the LED 17, the wireless communication switch 16, the power button 14, the mail button 23, etc. are integrated. The embedded controller/keyboard controller IC 119 turns on/off the power supply of the main part or entire body of the computer 10, in cooperation with the power supply circuit 120, in accordance with the user's operation of the power button 14.

The power supply circuit 120 generates the operation power to be supplied to each component of the computer 10, with the external power supply fed via a battery 121 or an AC adaptor 122. The operation power is fed from the power supply circuit 120 to the EC/KBC 119 even when the main component of the computer 10 is in the power-off state.

The APU 130 is a control device for controlling the sending and reception of electronic mails in cooperation with the EC/KBC 119, and is composed of a one-chip microcomputer. The operation power is fed from the power supply circuit 120 to the APU 130 even when the main component of the APU 130 is in the power-off state.

A memory 141 is connected to the APU 130 to store the OS, control program, user's mail account, mail server information, trigger information to be described later, etc. The APU 130 has a function of monitoring operations of the communication devices 131 to 134. In other words, the APU 130 is electrically connected to each of the communication devices 131 to 134 via a serial bus (for example, SMBUS, USB, etc.), by the point-to-point system, and can make direct communication with each of the communication devices 131 to 134. By executing communication with each of the communication devices 131 to 134, the APU 130 discriminates whether or not each of the communication devices 131 to 134 is in a state allowing communication with an external device via a wired or wireless network. In addition, the APU 130 also has a function of controlling the sub-display 21.

Moreover, the APU 130 is also connected to the south bridge 115 via a serial bus (for example, SMBUS, USB, etc.) Communication between the CPU 111 and the APU 130 can be thereby executed when the power of the computer 10 is turned on. Thus, the operations of the APU 130 can be monitored by the operating system when the power of the computer 10 is turned on.

The communication device 131 is a wireless communication device, which executes wireless communication with a base station under a wireless communication standard such as 3G Wireless WAN (WCDMA, HSDPA, etc.) 3G Wireless WAN is a wide-area wireless network such as a cellular telephone network. The communication device 132 is also a wireless communication device, which executes wireless communication with a base station (access point) under a wireless communication standard such as Wireless LAN (IEEE 802.11a/g, etc.).

The communication devices 133, 134 are wired communication devices. The communication device 133 executes communication with an external device via the Wired LAN. The communication device 134 is composed of, for example, a modem, which executes communication with an external device via the telephone network.

When the power of the computer 10 is turned off, too, the operation power is fed from the power supply circuit 120 to the communication devices 131 to 134. When the power of the computer 10 is turned off, each of the communication devices 131 to 134 is operated in a low power consumption mode.

In the system shown in FIG. 3, the APU 130 also functions as a discriminator which discriminates whether or not the communication devices can be utilized on the timing of executing data communication with an external device such as a mail server for the purpose of receiving electronic mails. If it is discriminated that the communication devices can be utilized, the EC/KBC 119 accesses the mail server to receive preset information of the electronic mails. The preset information includes names of mail senders, mail addresses, number of mails, keywords corresponding to subjects and texts of the mails, etc. If these information items and information on trigger conditions preset in the memory 141 match, the EC/KBC 119 starts the computer 10.

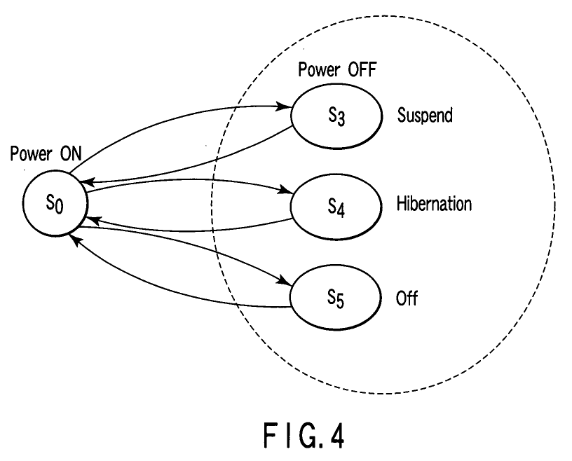

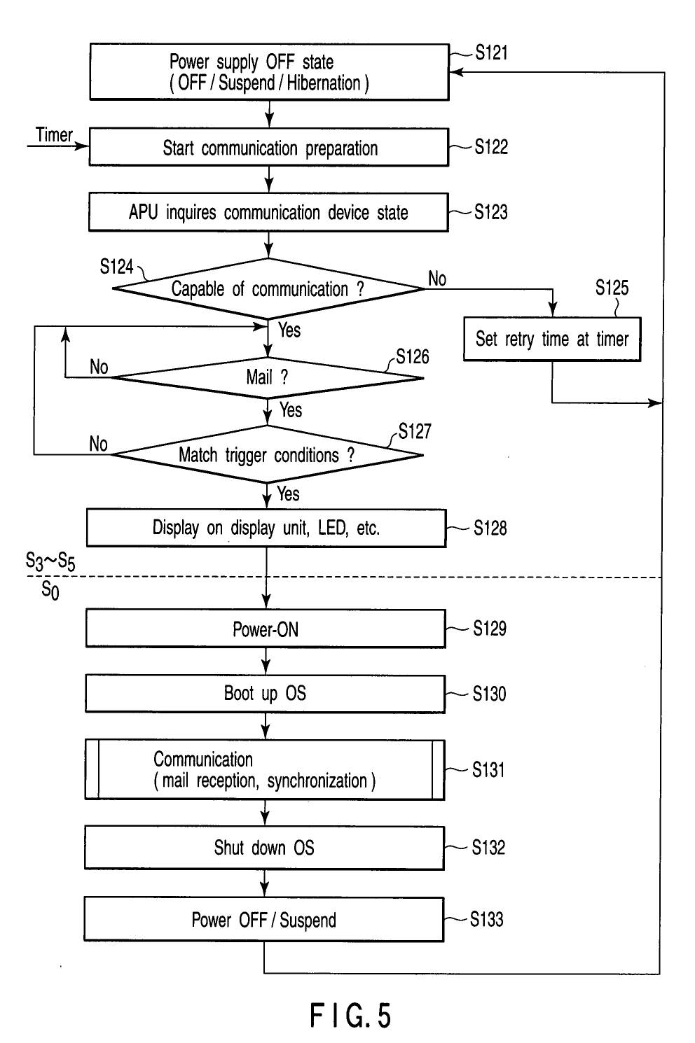

FIG. 4 shows the shift of the system state of the computer 10. The computer 10 supports four system states S0, S3, S4, and S5. S0 represents an operable state in which the power of the computer 10 is turned on. S3 (suspend), S4 (hibernation), S5 (off) are power-saving states of turning down the power of the computer 10.

In any state of S3, S4 and S5, the operation power is fed to the EC/KBC 119, the APU 130 and the communication devices 131 to 134.

The function of the APU 130 can be utilized when the computer 10 is set in any state of S3, S4, S5. In other words, if reception of an electronic mail is executed by the APU 130 and the electronic mail matches the trigger information, the system state of the computer 10 is shifted from S3, S4 or S5 to S0. After the reception of an electronic mail is executed in S0, the system state of the computer 10 is shifted to S3, S4, or S5. The timing of executing the reception is preliminarily scheduled.

Next, basic processing of the APU 130 is described with reference to a flowchart of FIG. 5.

The timing of executing the data communication by the APU 130 is managed by a timer 140 provided in the EC/KBC 119.

During a period during which the main component of the computer 10 is in the power-off state (S3, S4, or S5) (block S121), the EC/KBC 119 discriminates presence or absence of arrival of the timing of executing the data communication in accordance with a value of the timer 140. When the timing of executing the data communication arrives, preparation for the communication is started (occurrence of timer event) (block S122).

The APU 130 inquires of the communication device to be utilized, of the communication devices 131 to 134 (block S123). If the communication device to be utilized is ready for communication (YES in block S124), the APU 130 makes communication with the mail server to confirm whether new mails have arrived at the mail server (block S126). If it is discriminated by the APU 130 that new mails have arrived (YES in block S126), the APU 130 receives necessary information of the new mails and discriminates whether the necessary information items match preset trigger conditions (block S127).

The necessary information items of the new mails are names of senders of the new mails, mail addresses of the new mails, number of the new mails, keywords corresponding to the subjects and texts of the new mails, etc. The trigger conditions are names of senders of the new mails, mail addresses of the new mails, number of the new mails, keywords corresponding to the subjects and texts of the new mails, remaining time of the battery of the computer 10, etc. To discriminate whether the necessary information items match the trigger conditions, for example, mail addresses of the senders are preliminarily registered in the trigger information, and the only address information of the new mails is received by the APU 130. Besides the trigger conditions, the APU 130 discriminates whether or not the remaining time of the computer 10 is, for example, more than 10 percent. If the remaining time of the computer 10 is more than 10 percent, the APU 130 discriminates that the necessary information items match the trigger conditions.

In addition, when a new mail is received, the mail is not deleted in the mail server but is suitably read in the state of remaining new mail. Thus, when the mails are read in the following block S, the mails can be processed similarly to general new mails.

If it is discriminated in block S124 that the communication device to be utilized is not ready for communication (NO in block S124), a retry time (for example, one minute later) is set at the timer 140 (block S125).

If the APU 130 discriminates in block S127 that the necessary information items match the trigger conditions (YES in block S127), the APU 130 displays the mail addresses of the matching mails or the remaining time of battery, on the sub-display 21, and executes processing such as turning on the LED 17 (block S128). Then, when the APU 130 notifies the EC/KBC 119 of an instruction of power-on of the computer 10, the power of the EC/KBC 119 is turned on such that all the functions of the computer 10 including the main component become in an operable state (block S129). After block S129, the APU 130 shifts to the state S0 and is set under control of the CPU 111.

The power of the computer 10 including the main component can also be turned on in accordance with user's manual operations by stopping the processing in the state of block S128.

In response to the power-on of the computer 10 including the main component, the operating system (OS) is booted up (block S130), and a communication program is activated under control of the utility program. The communication program is an application program operated on the operating system (OS).

The communication program executes data communication for reception of electronic mails or data communication for synchronization of schedule data, by employing any one of the communication devices 131 to 134 (block S131). After the execution of the data communication is completed, the operating system (OS) is automatically shut down by the utility program (block S132). Then, the EC/KBC 119 turns off or suspends the power of the main component of the computer 10 (block S133).

Block S S129 to S133 are regularly executed while the power of the main component of the computer 10 is turned on.

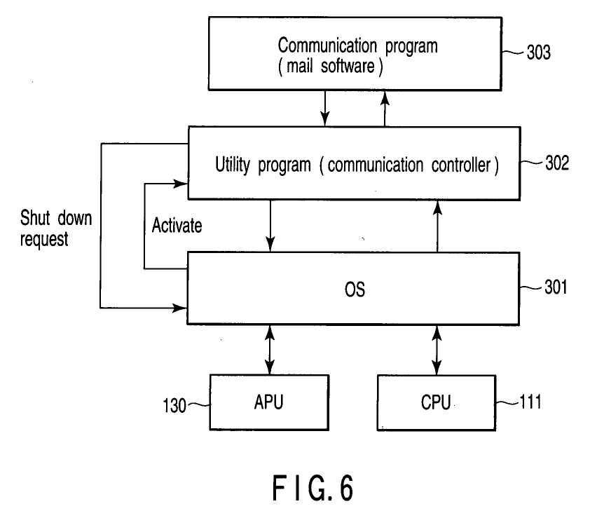

Next, the relationship among the operating system (OS), the utility program and the communication program is described with reference to FIG. 6.

A utility program 302 is a resident program which is first executed by OS 301 when the OS 301 is booted up. The utility program 302 activates a communication program 303 and urges the communication program 303 to execute data communication with an external device. When the execution of data communication of the communication program 303 is completed, the utility program 302 issues a shutdown request to the OS 301.

Thus, when the power of the main component of the computer 10 is turned on, the utility program 302 urges the communication program 303 to execute data communication with an external device. In addition, the utility program 302 functions as a communication controller configured to turn off the power of the main component of the computer 10 after the execution of data communication. Since the utility program 302 is operated by the CPU 111, the CPU 111 controls the communication. At this time, the APU 130 is set under management of the CPU 111. After the power of the main component of the computer 10 is turned off after the execution of data communication, the control of the APU 130 is released by the CPU 111. After the power-off of the main component of the computer 10, the APU 130 returns to the initial state of regularly checking the mails (block S121 in FIG. 5).

As described above, it is discriminated by the computer 10 whether or not the communication device is employable on the timing of executing data communication with an external device. By controlling the power of the main component of the computer 10 on the basis of the discrimination result, the power consumed in the operable state irrespective of inoperability in communication, can be saved.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a communication unit making communication with a mail server;
a searching unit discriminating whether or not a new mail has arrived at the mail server;
a main controller controlling the communication unit and the searching unit, and obtaining a new mail;
a main power supplier supplying power to the main controller; and
a sub-controller discriminating whether or not a new mail has arrived on the predetermined timing by the searching unit during suspension of the main controller, obtaining the new mail via the communication unit if the new mail has arrived, and urging the main power supplier to supply the power and setting the main power supplier in an operable state if any item of information included in the new mail meets a predetermined condition.

2. The apparatus according to claim 1, wherein the sub-controller comprises a display unit; and
if the information included in the obtained new mail meets the condition, the sub-controller displays predetermined information on the display unit.

3. The apparatus according to claim 1, wherein the information meeting the condition includes at least one of names of mail senders, mail addresses, number of mails, and keywords corresponding to subjects and texts of mails.

4. The apparatus according to claim 1, wherein the information included in the new mail is at least one of a name of a sender sending the new mail, a mail address of the new mail, and keywords corresponding to a subject and a text of the new mail.

5. The apparatus according to claim 1, wherein after the new mail is obtained by the main controller, the main controller is set in a suspended state and power supply of the main power supplier is set in an off state.

6. The apparatus according to claim 2, wherein if an instruction of power supply is given to the main power supplier after the predetermined information is displayed by the display unit, the main controller becomes in an operable state and obtains the new mail via the communication unit.

7. A method of receiving a mail, comprising:
setting a main controller which executes communication with a mail server and obtains a mail, in a suspended state, and stopping power supply to the main controller;
discriminating whether or not a new mail is stored in the mail server on the predetermined timing by a sub-controller, while the main controller is suspended;
if a new mail is stored, obtaining the new mail and discriminating whether or not any items in information included in the new mail meet predetermined conditions; and
if the items in the information meet the predetermined conditions, power supply to the main controller is started and the main controller is set in an operable state.

8. The method according to claim 7, wherein after the main controller obtains the new mail, the main controller is set in a suspended state and power supply to the main controller is stopped.
